(19) United States
(12) Patent Application Publication
(10) Pub. No.: US 2024/0083095 A1
(43) Pub. Date: Mar. 14, 2024

(54) APPARATUS AND METHOD FOR PRODUCING CONTAINERS

(71) Applicant: Krones AG, Neutraubling (DE)

(72) Inventors: Andreas Stopfer, Regensburg (DE); Konrad Senn, Alteglofsheim (DE)

(21) Appl. No.: 18/461,353

(22) Filed: Sep. 5, 2023

(30) Foreign Application Priority Data
Sep. 9, 2022 (DE) 10 2022 122 969.6

(51) Int. Cl. B29C 49/64; B29C 49/78

(52) U.S. Cl. CPC B29C 49/6418; B29C 49/786; B29C 2049/78675; B29L 2031/712

(57) ABSTRACT

The disclosure relates to the production of containers comprising: a heating device for preforms of the containers, the heating effect of which is adjustable, a forming device such as a stretch blow-molding device for forming the preforms into containers, a measuring device which is designed to perform a transmission measurement for light, such as infrared light, which passes through the container, a closed-loop control which is designed to process the result of the transmission measurement and a target value of the transmission measurement and, based upon the result of the transmission measurement and the target value, to adjust the heating effect of the heating device and/or one or more adjustable parameters of the forming device. The disclosure further relates to a corresponding method.

### CROSS REFERENCE TO RELATED APPLICATION

The present application claims priority to German Patent Application No. 10 2022 122 969.6 filed on Sep. 9, 2022. The entire contents of the above-listed application are hereby incorporated by reference for all purposes.

### TECHNICAL FIELD

The disclosure relates to an apparatus and a method for producing containers such as PET containers with a stretch blow-molding method.

### BACKGROUND

The document EP 1 998 950 is known in which a wall thickness measurement on the container is performed, and the heating device of the preforms is accordingly regulated.

### SUMMARY

A disadvantage of this is that a specific wall thickness measurement must be performed, which is difficult for some container geometries. In addition, only the one associated heating device is regulated using the determined wall thickness.

It is an object of the present disclosure to provide a closed-loop control for the production of containers that is more manageable in practice.

The object is achieved by the apparatus and the method as described herein.

A transmission measurement is performed on the produced container. The purpose of this is not to determine the wall thickness, but rather the amount of and, if necessary, the nature of the material in the light path. On the one hand, this includes the material of two container walls, and on the other also works for container parts which run obliquely to the path of the transmission measurement. The latter are found, for example, in the shoulder region of a bottle, a container not precisely centered in the light path, or in a container with profiling. Profilings are structures, such as depressions, or elevations on the wall of the container, which are provided on the inside and/or on the outside of the wall, e.g., for decorative purposes, or for identification with, for example, a monogram.

The result of the transmission measurement is used to adjust the heating effect of the heating device and/or one or more adjustable parameters of the forming device.

The containers can be bottles such as PET bottles, for example.

The transmission measurement is performed, for example, using light, such as infrared (IR) light. In this case, the transmission can occur at two different wavelengths (both in the infrared range) in order to eliminate or compensate for influences from other media in the light path such as air humidity. One wavelength preferably lies within the range of absorption in the material to be investigated which is higher—such as at least 5 or 10 times higher—than the absorption at the other wavelength. This allows the amount of material in the light path to be detected quite reliably.

For the selection of the wavelength, optical filters can be provided in the light paths of two different detectors, and the two light paths can be obtained with a beam splitter which divides the light through the container after transmission.

It can be provided that the measurement signals of the detectors be provided separately for the two wavelengths of the closed-loop control, but it can also be provided that the measurement signals be processed in a measuring bridge upstream of the closed-loop control, e.g., by (weighted) differentiation, and the differentiation result be made available to the closed-loop control.

In the closed-loop control, for which, for example, no defined wall thickness is specified as the target value, a historical measurement which was recorded using the measuring device can be used as the target value. This eliminates the need to calibrate a measuring device to determine a specific wall thickness. Because a historical measurement is used, no consideration of other factors that influence the measurement is necessary. Experience has shown in practice that, for example, machine vibrations, the specific container shape, profilings of the container, and other things influence the measurement. These factors are already taken into account by the use of a historical measurement. The historical measurement can be obtained, for example, by producing and measuring a container with the measuring device and deciding to store the measured values of this container as target values for later measurements using the measuring device.

Optionally, it can be provided that the measuring device determine the transmission at several points of the container. For this purpose, it can be provided, for example, that the container be moved relative to the measuring device, and, while it is being moved relative to the measuring device, several transmission measurements be performed with the measuring device so that several transmission measurements are performed at different locations. These transmission measurements determine transmission at different points, but approximately at the same height of the container, provided that the container is moved with the direction of its height perpendicular to the direction of movement. The direction of the height of the container can be oriented, for example, from a container base to the opening of the container and/or along a longitudinal axis of the container.

The results of the transmission measurement (for the respective wavelengths separately or, as described above, already processed in the measuring bridge) are averaged, for example. In this case, the averaging can also be performed only for some of the measured values, such as for those measured values which are as close as possible to the center of the container (center in the transport direction). For example, only two, three, four, five, or six of the measured values measured approximately at the same height can be averaged. The mean value determined in this way can then be used for the closed-loop control. By using the transmission measurement from several places which are approximately at the same height of the container, a wide region of the container is measured, and the measurement becomes less sensitive to smaller disturbances. Instead of averaging, the values can also only be added or otherwise processed to form a measurement result.

The measuring device can also be designed such that it can perform a transmission measurement at several points of the container at different heights of the container. For this purpose, the measuring device can have several measuring sensors, each of which can perform a transmission measurement of the container. The various measuring sensors can have a common (IR) light source, or several measuring sensors from one of several groups of measuring sensors can have a common (IR) light source, wherein each measuring sensor can also have its own (IR) light source. Each measuring sensor has a detector for detecting the transmitted light, wherein the detector can have several sub-detectors which are sensitive to different wavelengths of the transmitted light. Each measuring sensor can measure the transmission of (IR) light at different wavelengths, such as at two different wavelengths.

The measuring sensors (all or some) can be provided, for example, at equidistant intervals, such as at intervals of between 0.5 and 3 cm—for example, 1 cm. In this way, the most complete possible image of the transmission of the container can be obtained, and this independently of the specific length or shape of the container. Such a measuring device with a plurality of measuring sensors can be used without mechanical modifications for different types of containers, such as for container types with container shapes of varying length.

The closed-loop control can adjust the heating effect of the heating device. This can be done, for example, by the power or the temperature of the heating device being specified by the control system. To adjust the temperature, an inner control loop can be provided which performs the adjustment of the temperature predetermined by the closed-loop control.

The apparatus can have several heating devices, the heating effect of which can be adjusted by the closed-loop control (as explained above, by specifying the temperature of the heating device or the heating output). The closed-loop control can, for example, adjust the heating effect of several or all heating devices. For this purpose, the closed-loop control can access all data made available by the measuring device. The transmission measurement values from all or several of the measurement sensors can also be used and processed by the closed-loop control.

This allows better closed-loop control of the heating equipment, since the amount of the material and nature of the material in the measuring paths of several measuring sensors can be taken into account for the closed-loop control.

For example, more measuring sensors can be provided than heating devices. As a result, the information from several measuring sensors can be used for adjusting the heating effect of one or more of the heating devices.

In addition to or instead of the heating effect of the heating device(s), one or more adjustable parameters of the forming device can also be adjusted by the closed-loop control. In a stretch blow-molding machine, as an example of a forming device, this concerns, for example, the moment at which a certain pressure (such as one or more pre-pressures, intermediate pressures, final pressures) is applied, and/or the level of the respective pressure. The closed-loop control can, for example, adjust the time point of the stretching process and the speed of the stretching process (such as the speed of the stretching rod), also or independently of the adjustment of a pressure.

### BRIEF DESCRIPTION OF THE FIGURES

Exemplary embodiments of the apparatus and the method will be illustrated with reference to the accompanying figures. In the drawings:

FIG. 1 shows a preform with several heating devices

FIG. 2 shows a container in a measuring device

FIG. 3 shows a further illustration of a container in a measuring device, and

FIG. 4 shows a schematic sketch of the apparatus.

### DETAILED DESCRIPTION

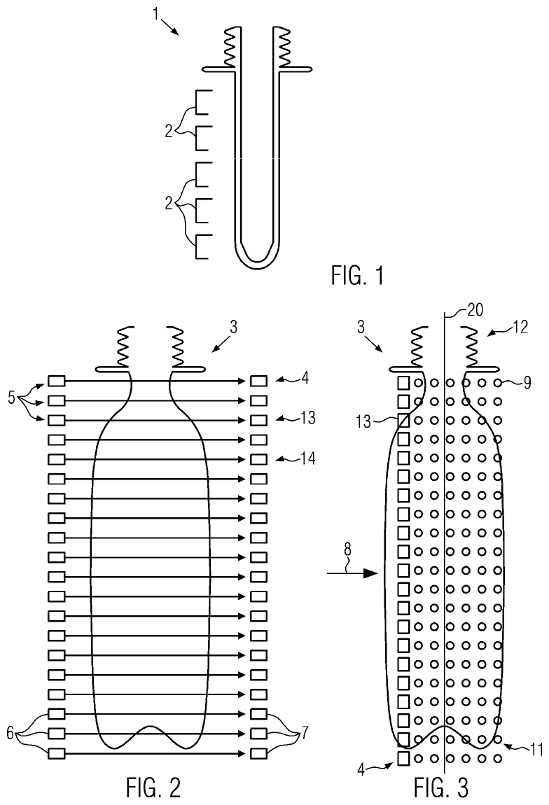

FIG. 1 shows a preform 1 which is located in a heating station in front of five heating devices 2. The five heating devices 2 are arranged vertically one above the other. Instead of five, more or fewer heating devices 2 can also be provided. It can also be possible that not all of the several heating devices 2 are used to heat a preform, since the preform is not long enough for it to be located in front of all the heating devices 2. The closed-loop control would then also only regulate the heating devices 2 used.

The heating devices 2 can be or include infrared radiators, or radiant heaters, or microwave radiators. The temperature or heating power of the heating devices 2 is adjustable. As a result, when there are several heating devices 2, these different regions of the preform 1 can be heated to various extents. Typically, only the belly region or tubular region of the preform 1 is heated to the temperature necessary for formation (shown at the bottom or below the collar in FIG. 1), not a collar and threaded region, which are shown at the upper end of the preform in FIG. 1. Depending upon how strongly a region of the part of the preform to be formed is heated, a shape of the container is produced during the forming process which delivers a different result during the transmission measurement. The temperature will have an influence on the amount of material in the light path of the transmission measurement, as well as on the nature of the material. With PET, this can, for example, be the degree of crystallinity, the orientation of the molecular chains, or the moisture content, which can all have an influence on the transmission measurement.

FIG. 2 shows a container 3 which is located in a measuring device 4. In the measuring device 4, twenty measuring sensors 5 are provided here by way of example. More or fewer measuring sensors 5 can also be provided. The lowermost measuring sensor 5 cannot be used, since the container 3 is too short to reach the region of the lowermost measuring sensor 5. The several measuring sensors 5 each have a light source 6 which can emit IR light along a measurement path. Each light source 6 can be operated in a pulsed manner and emit individual light pulses. It can also emit light continuously. Instead of several light sources 6, also only one common light source can be provided. A common light source, which is operated continuously or in a pulsed manner, can also be provided for each of several groups of several detectors 7.

Each detector 7, which performs a transmission measurement of the container, detects the light that was transmitted through the container, wherein the light passes through two walls of the container 3 before it is detected by the detector 7.

Each detector 7 can divide the transmitted light into two or more light beams. A filter can be located in each of the divided beam paths so that the filters allow light at different wavelengths to pass through. Photodetectors which can measure the light intensity can be located in the beam path behind the filters. The signals of the photodetectors of a measuring sensor can be switched in a measuring bridge such that, when there is no container material in the light path, the signals cancel each other in such a way that approximately zero is output as the measurement result, whereas a measurement result different from zero is output if material is present.

The measuring sensors 5 can be provided equidistantly, as shown in FIG. 2. The measuring sensors can have a light path in a direction perpendicular to the longitudinal axis of the container 3. The measuring sensors 5 can be arranged vertically, one above the other. If the container 3 stands or hangs vertically, then the light path may be provided horizontally. The light paths of several measuring sensors 5 can each be provided parallel to one another and/or be of equal length.

The signals or the signal of each measuring sensor 5 is/are made available individually to the closed-loop control. The closed-loop control can also be provided with the signals of each detector individually.

As shown in FIG. 3, containers can be transported hanging or standing through a measuring device with a conveyor. The movement is illustrated by the arrow 8 in FIG. 3. Several transmission measurements can be performed at the same height on a container 3. For this purpose, several transmission measurements are performed successively when the container 3 is moved by the measuring device 4, and they are then performed at different points of the container 3 due to the movement.

FIG. 3 shows the measuring sensors and the container in a viewing direction perpendicular to that of FIG. 2. The viewing direction is parallel to the direction of the light path of the measuring sensors (perpendicular to the drawing plane).

The locations at which the measuring sensors can have measured the transmission of the container, for example, are marked with small round circles 9. There, the transmission could have been measured before the container was moved in the direction of movement according to arrow 8 to the position in which it is shown in FIG. 3.

The circles which are shown horizontally next to each other in FIG. 3 represent transmission measurements which can have been performed approximately at the same height on the container. The circles which are shown above one another in FIG. 3 correspond to transmission measurements performed at different heights of the container.

Of the transmission measurements which are shown approximately at the same height in FIG. 3, only a few can be processed further—for example, for averaging. Optionally, only those two, three, or four or more transmission measurements at approximately the same height of the container that are as close as possible to the longitudinal axis 10 of the container are processed further, such as for averaging. For example, only the one or two transmission measurements at the location just to the right or left of the longitudinal axis 10 can be further processed, such as for averaging.

The direction of the height in FIG. 3 runs along the longitudinal axis 10 of the container. It can also alternatively run along the direction from the bottom 11 of the container 3 to its opening 12. In FIG. 3, that is the same direction as that of the longitudinal axis 10.

The measuring sensor marked with the reference sign 13 in FIGS. 2 and 3 measures the transmission of the container in the region of the shoulder of the container. Here, as can be seen clearly in FIG. 2, the wall of the container 3 runs obliquely to the light path of the transmission measurement. As a result, the transmission measurement will detect more material than the transmission measurement of the measurement sensor 14, which is performed, for example, two or three measurement sensors further down. The measuring sensor 13 and 14 therefore delivers different values for the transmission or for the quantity of material in the light path at the same wall thickness of the container at the location of the measurement of the measuring sensor 13 and 14. However, this is not a hindrance, since the target value of the closed-loop control, e.g., a historical value of the transmission measurement, has likewise measured this difference. By regulating to a historical measured value and not to a predetermined wall thickness, the apparatus can be used for different container types, shapes, and sizes, without the need for mechanical modifications of the measuring device.

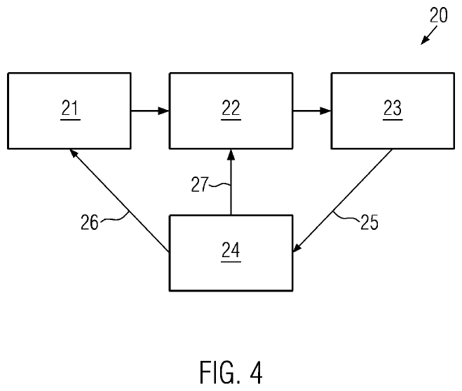

FIG. 4 shows a schematic illustration of an apparatus 20. The apparatus comprises one or more heating device(s) 21, a forming device 22, a measuring device 23, and a closed-loop control 24. As described above and below, the data of the measuring device 23 are made available to the closed-loop control 24 (see arrow 25). The closed-loop control 24 can accordingly adjust the heating effect of the heating device 23 (see arrow 26). Also, or instead of regulating the heating device, the closed-loop control 24 can adjust adjustable parameters of the forming device 22. This can, for example, be the time point of applying a pre-pressure, and/or an intermediate pressure and/or an end pressure, in a stretch blow-molding process. The time point of the stretching process and/or the speed of a stretching rod for the stretching process can also be adjusted by the closed-loop control.

The closed-loop control adjusts the heating effect of the heating device(s) and/or the parameters of the forming device such that the results of the transmission measurement (actual values) are as dense as possible at predetermined (target) values of the transmission measurement.

The result of the transmission measurement is determined to a significant extent by the amount of material of the container in the light path of the transmission measurement. This amount of material can be influenced in a targeted manner by the heating effect—especially when there are several heating devices—as well as by adjustable parameters of the forming device.

It can be provided for the forming device to have several molds for forming containers, wherein each mold is designed on its own to form preforms into containers. The closed-loop control can be designed such that the result or results of the transmission measurement of a container are assigned to one of the several molds. Then, the closed-loop control can average several results of transmission measurements of different containers assigned to the same mold. For example, the results can be averaged of the transmission measurements from more or less than 5 or more or less than 10 containers which were assigned from the same mold. The values averaged in this way are then used for regulating the heating device and/or the adjustable parameters of the forming device. As a result, the adjustments by the closed-loop control are independent of individual containers and more reliably detect systematic problems or misadjustments by the closed-loop control.

The closed-loop control can be designed, for example, in the form of a neural network or an artificial intelligence (AI) which processes numerous measured values or measurement results of the measuring sensors into a few output values, wherein fewer output values are used as measured values. In an example, the closed-loop control may be formed as a controller with instructions stored in memory for carrying out the various actions described herein, including receiving measurement values from the sensors described herein and generating output control signals sent to the actuators as described herein, such as to adjust heating or forming as described. The controller may be a digital controller implement by instructions stored in the memory to carry out the control actions in a real-time control manner. The closed-loop control may be carried out by utilizing the target and comparing to measured values, the difference of which is then processed by a control algorithm, such as a P-I-D controller to generate the control output. While various example algorithmic operations are described herein in sentence form, and can be implement in the controller.

1. Apparatus for manufacturing containers comprising:
a heating device for preforms of the containers, the heating effect of which is adjustable,
a forming device having adjustable parameters which influence the forming process,
a measuring device which is designed to perform a transmission measurement for light that passes through the container,
a closed-loop control that is designed to process the result of the transmission measurement and a target value of the transmission measurement and, based upon the result of the transmission measurement and the target value, to adjust
the heating effect of the heating device and/or
one or more adjustable parameters of the forming device.

2. Apparatus according to claim 1, wherein the transmission measurement is provided with light at two different wavelengths.

3. Apparatus according to claim 2, wherein the result of the transmission measurement for the light of the two different wavelengths can be made available individually to the closed-loop control, or the result of the transmission measurement for the light of the two different wavelengths can first be calculated as a value, and then be made available to the closed-loop control as a measured value.

4. Measuring device according to claim 1, wherein the target value is determined from a historical measurement value which was previously obtained with the measuring device.

5. Apparatus according to claim 1, wherein the measuring device is provided to perform the transmission measurement on a container several times at different locations of the container at approximately the same height of the container, and to average the results, add them or otherwise process them to form a single measurement result, and to provide the measurement result obtained in this way for the closed-loop control.

6. Apparatus according to claim 5, wherein the measuring device has several measuring sensors which can perform transmission measurements on a container at different points of the container at different heights of the container, and the results of the measuring sensors can be made available individually to the closed-loop control.

7. Apparatus according to claim 1, wherein the measuring device is designed such that the light passes between the illumination and a receiver of the light through two walls of the container.

8. Apparatus according to claim 1, wherein the closed-loop control is designed to store a measured value of the transmission measurement as a target value for future measurements.

9. Apparatus according to claim 1, wherein several heating devices are provided whose heating effect is adjustable and which can heat different regions along a longitudinal axis of the preform, and wherein the measuring device has several measuring sensors which, along the longitudinal axis of the container, at different locations, can carry out a transmission measurement for light that passes through the container, wherein the closed-loop control can regulate the heating effect of the several heating devices based upon the several measuring sensors.

10. Method for manufacturing containers, having the steps of:
heating a preform with a heating device by its heating effect,
forming the preform into a container,
performing a transmission measurement on the container with a measuring device, and
regulating the heating effect of the heating device on the basis of the result of the transmission measurement and on the basis of a historical measured value of the transmission measurement which was obtained with the measuring device.

11. Method according to claim 10, wherein a transmission measurement with the measuring device is performed on a container, and the result of the transmission measurement is stored as a historical measured value of the transmission measurement in the closed-loop control.

12. Method according to claim 11, wherein several transmission measurements are performed on a container at approximately the same height on the container, and the results are averaged, added, or otherwise processed to form a single measurement result, and the measurement result obtained in this way is made available for the closed-loop control.

13. Method according to claim 12, wherein several transmission measurements are performed on a container at different locations of the container at different heights of the container, and the results are individually provided for the closed-loop control.

14. Method according to claim 13, wherein several heating devices are provided, the heating effect of which is adjustable, which heat different regions along a longitudinal axis of the preform, and wherein the measuring device has several measuring sensors which, along the longitudinal axis of the container, at different locations, perform a transmission measurement for light, which passes through the container, wherein the closed-loop control regulates the heating effect of the several heating devices based upon the several measuring sensors.

15. Method according to claim 14, wherein, based upon the result of the transmission measurement, the closed-loop control regulates not only the heating effect of the heating device, but also other parameters relevant to the forming step.
